(19) United States
(12) Patent Application Publication
(10) Pub. No.: US 2023/0304560 A1
(43) Pub. Date: Sep. 28, 2023

(54) MOTOR VEHICLE HAVING A VIBRATION DAMPER

(71) Applicant: Dr. Ing. h.c. F. Porsche Aktiengesellschaft, Stuttgart (DE)

(72) Inventor: Jan Kralicek, Weissach (DE)

(21) Appl. No.: 18/127,287

(22) Filed: Mar. 28, 2023

(30) Foreign Application Priority Data
Mar. 28, 2022 (DE) 10 2022 107 271.1

(51) Int. Cl. F16F 7/108; F16F 7/10

(52) U.S. Cl. CPC F16F 7/108; F16F 7/1005; F16F 2224/0208; F16F 2224/025; F16F 2222/08; F16F 2230/0005

(57) ABSTRACT

A motor vehicle (2) has at least one mechanical structure (3), such as a vehicle frame, and has a vibration damper (4) associated with the structure (3) for damping vibrations of the structure (3). The vibration damper (4) has a retainer (5) and a damper mass (7) resiliently mounted in the retainer (5) by a spring element (6). The vibration damper (4) and the structure (3) are connected operatively by a flat spring (8). The retainer enables the vibration damper (4) to be mounted on the flat spring (8) for sliding movement along a longitudinal axis (L) of the flat spring (8). The vibration damper (4) and the flat spring (8) form a damper arrangement (1) in which the spring element (6) and the flat spring (8) are connected in series.

### CROSS-REFERENCE TO RELATED APPLICATION

This application claims priority on German Patent Application No 10 2022 107 271.1 filed Mar. 28, 2022, the entire disclosure of which is incorporated herein by reference.

### BACKGROUND

Field of the Invention The invention relates to a motor vehicle having a vibration damper for damping vibrations of a frame or other structure of the motor vehicle.

Related Art DE 10 2006 020 785 A1 discloses a vibration damper that can be used to dampen vibrations of a mechanical structure of a vehicle. The vibration damper comprises a damper mass that is connectable to the structure by a spring element with a housing and a piston slidably mounted in the housing to adjust a tuning frequency of the vibration damper, if necessary. However, the design enables the vibration damper to be suitable for only a relatively narrow band effect. Thus, only a comparatively low proportion of the vibrations of the structure can be absorbed by the vibration damper. The vibration damper is not sufficiently suitable for applications that require an absorption of vibrations over a broad frequency range.

US 2021/0025469 discloses a vibration damper similar to DE 10 2006 020 785 A1 and hence with a design that allows only a narrow band effect.

An object of the invention is to provide a vibration damper for a motor vehicle and that is suitable for applications that require absorption of vibrations over a broad frequency range.

### SUMMARY

One aspect of the invention relates to a motor vehicle that has at least one mechanical structure, such as a vehicle frame, and a vibration damper associated with the structure for damping vibrations of the structure. The vibration damper can be coupled indirectly to the mechanical structure. The vibration damper comprises a retainer and a damper mass mounted resiliently in the retainer by a spring element.

The vibration damper and the structure of the motor vehicle are connected operatively by a flat spring. Additionally, the retainer enables the vibration damper to be slid along a longitudinal axis of the flat spring. Thus, the vibration damper and the flat spring collectively form a damper arrangement, in which the spring element and the flat spring are connected in series. Accordingly, the vibration damper or the damper arrangement has a broader band effect than dampers of the prior art and also provides flexible tuning frequencies that can be adapted to damping requirements of the structure.

In the context of the present invention, the term “tuning frequency” means a natural frequency of the vibration damper or the damper arrangement that is to be tuned to the frequency of vibrations of the structure that are be eliminated. In other words, the tuning frequency corresponds to that frequency of vibrations of the structure that are absorbed by the vibration damper or the damper arrangement.

The serial connection of the spring element with the flat spring in the motor vehicle described herein enables a tuning frequency of the damper arrangement that results, not only from the rigidity of the spring element as in the prior art, but from both the rigidity of the spring element and the rigidity of the flat spring, i.e. the rigidity of a further or second spring element. The specific spring leaf design results in multiple damper arrangement natural frequencies and a broader band effect. This allows the absorption of a broad frequency range of vibrations of the structure and thus an advantageous damping of the structure. The slidable mounting of the vibration damper also ensures a position of the vibration damper on the flat spring that can be adjusted as needed, thereby allowing the effective length and thus the rigidity of the flat spring and the damper arrangement to be variable. Accordingly, tuning frequencies can be changed or adjusted as needed. In this respect, the motor vehicle enables a simple adaptation of the tuning frequencies to individual requirements of the motor vehicle or the structure to be dampened. This adaptation can be carried out in a fast and favorable manner. The damper arrangement further is robust and light weight.

In some embodiments, the vibration damper can be mounted slidably relative to the flat spring such that the vibration damper can be brought into at least first and second positions spaced apart along the longitudinal axis of the flat spring. This allows an adjustment of the tuning frequency in a simple manner. The vibration damper may be lockable in the first position and the second position by a locking apparatus, for example a locking system or magnetic means. Thus, an unwanted displacement of the vibration damper and an undesirable change in the pre-adjusted tuning frequency resulting from the vibrations of the structure can be avoided.

The vibration damper can comprise a mounting projection extending away from the retainer. The mounting projection can pass through an elongated hole in the flat spring or can engage around the flat spring. Either of these options enables slidable mounting of the vibration damper along the longitudinal axis of the flat spring. This is a constructively easily implementable solution to ensure intended displacement of the vibration damper. This damper arrangement can be manufactured simply and inexpensively while being robust and durable.

The flat spring can be flat with a rectangular cross-section and can be made of metal. In particular, the flat spring can be a stamped plate. The flat spring thus is simple and inexpensive to manufacture. In some embodiments, the flat spring has a cross-section in which a width (y-direction) of the flat spring is significantly greater than a thickness (x-direction) of the flat spring. This shape gives the flat spring particularly advantageous springing properties. Thus, different tuning frequencies can be achieved by the different rigidity of the flat spring in the x-direction and y-direction. In the x-direction, the rigidity is comparatively low, so that the flat spring can act as an additional spring element upon excitation of the damper arrangement in the x-direction. In the y-direction, the rigidity of the flat spring is comparatively high, so that the flat spring has no or only a negligible spring effect when the damper arrangement is excited in the y-direction. If excited in a general direction, which is very often the case in vehicle construction, the damper arrangement functions with two relatively close tuning or natural frequencies and therefore covers a broad or broader frequency range.

The spring element of the vibration damper can be made from an elastomer. Elastomeric materials have advantageous elastic properties for vibration dampers and spring properties and are inexpensive and easy to process. Due to the design of the vibration damper, the elastomeric material, for example a rubber blend, acts as an elastic connection of the damper mass to the retainer and, in this respect, as a spring, through which the vibrations of the structure are transferred to the damper mass.

Some embodiments have an electromechanical actuator associated with the vibration damper. The actuator enables the vibration damper to be slid smoothly and/or continuously along the flat spring. Thus, the vibration damper can be displaced precisely. The actuator also enables a remotely controlled displacement of the vibration damper so that it can be moved by controlling a control unit. A direct access, such as for manual displacement of the vibration damper, is not required.

The flat spring can be fastened to the structure by a rigid retaining element at a fastening point. The retaining element is configured so that the flat spring has a fixed distance from the structure in the fastened state at the fastening point. The vibration damper of this embodiment is coupled slidably to the flat spring, and the flat spring is fastened to the structure to be dampened via the rigid connection. Thus, the flat spring is spaced from at least from portions of the structure so that the structure does not interfere with the vibration damping properties of the damper arrangement.

The vibration damper can be a first vibration damper arranged in a region of a first end of the flat spring, and the damper arrangement may comprise at least one second vibration damper in a region of the second end of the flat spring. The first and second dampers may be configured identically and are spaced apart from one another. The first and second vibration dampers may be mounted slidably on the flat spring for movement along the longitudinal axis of the flat spring. This damper arrangement has an even broader band effect and the tuning frequencies are variable or adjustable within an even broader frequency range, so that the vibration damping properties of the damper arrangement can be optimized further. Even if the first vibration damper and the second vibration damper can each only be brought into two different positions relative to the flat spring, in this way four different tuning frequencies can be represented.

Further advantageous configurations will emerge from the following description and the drawings.

### BRIEF DESCRIPTION OF THE DRAWINGS

FIG. 1 a schematic depiction of a damper arrangement of a motor vehicle.

FIGS. 2A and 2B each schematically depict a cross-section through the damper arrangement of FIG. 1.

FIG. 3 is a further development of the damper arrangement of FIG. 1.

FIG. 4 a diagram for explaining the effect of the damper arrangement.

### DETAILED DESCRIPTION

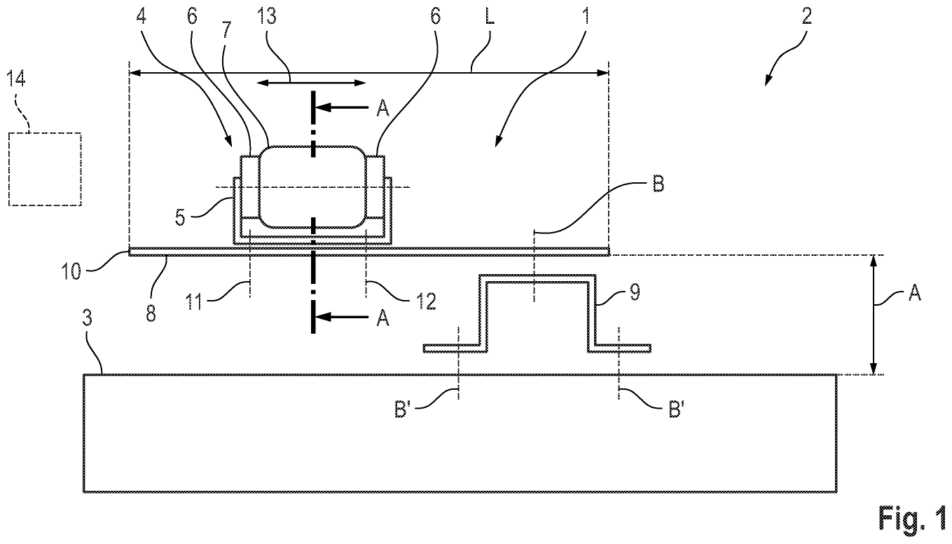

FIG. 1 illustrates a damper arrangement 1 of a motor vehicle 2. The damper arrangement 1 is associated with a structure 3 of the motor vehicle 2, such as a frame. The damper arrangement 1 is configured to dampen vibrations of the structure 3 that occur while driving the motor vehicle 2, such as vibrations generated by imperfections of a roadway.

The motor vehicle 2 or the damper arrangement 1 comprises a vibration damper 4 having a retainer 5 and a spring element 6 that mounts a damper mass 7 in the retainer 5. In this example, the spring element 6 is made of an elastomeric material, and the damper mass 7 is mounted in the retainer 5 by the spring element 6 such that the damper mass 7 can pivot with at least three degrees of freedom in the retainer 5.

The vibration damper 4 is connected operatively to the structure 3 by a flat spring 8 and a retaining element 9. The retaining element 9 of the illustrated embodiment is rigid and is associated with the flat spring 8. As shown in FIG. 1, the vibration damper 4 is arranged in the region of a free end 10 of the flat spring 8. The flat spring 8, in turn, is fastened to the rigid retaining element 9 at a fastening point B, preferably force-fit and/or form-fit, for example by a screw. In the present case, the retaining element 9 is fastened to the structure 3 at two further fastening points B′, for example screwed on.

The vibration damper 4 and the flat spring 8 form the damper arrangement 1 that is coupled mechanically to the structure 3 by the retaining element 9 to absorb and/or eliminate the vibrations of the structure 3. To this end, the vibrations are transferred to the damper mass 7 while interposing the flat spring 8 and the spring element 6, and thus the damper mass 7 is vibrated itself to eliminate the vibrations of the structure 3 or to absorb the vibrations from the structure 3.

The spring element 6 of the vibration damper 4 and the flat spring 8 are connected in series. Thus, an overall rigidity of the damper arrangement 1 is composed of the rigidity of the spring element 6 and the rigidity of the flat spring 8. The overall rigidity of the damper arrangement 1 results from the design (of the overall rigidity) of two tuning frequencies of the damper arrangement 1. The serial connection of the spring element 6 with the flat spring 8 achieves a broadband vibration damping and, in particular, a broader band when compared to tuning frequencies of known vibration dampers or damper arrangements. Thus, a higher proportion of vibrations of the structure 3 can be compensated by the damper arrangement 1.

The retaining element 9 is configured such that the flat spring 8 has a fixed distance A from the structure 3 in the fastened state at the fastening point B so as not to impede the corresponding vibration-damping properties of the damper arrangement 1. This ensures that the free end 10 of the flat spring 8 can vibrate or curve unhindered upon receiving the vibrations of the structure 3.

The retainer 5 is configured to enable slidable mounting of the vibration damper 4 along a longitudinal axis L of the flat spring 8 for further enabling a flexible adjustment of the tuning frequency to the respective damping requirements of the structure 3 in a simple manner. More particularly, the vibration damper 4 is mounted slidably relative to the flat spring 8 such that the vibration damper 4 can be moved relative to the flat spring 8 into at least a first position 11 and a second position 12 spaced from the first position 11. The positions 11, 12 shown in FIG. 1 each refer to a center point of the vibration damper 4 and a center of gravity of the damper mass 7. Displacing the vibration damper 4 along the longitudinal axis L of the flat spring 8 effectively varies the length of the flat spring 8 and the associated effective rigidity of the flat spring 9. This advantageously allows an adjustment of the overall rigidity of the damper arrangement 1 and thus its tuning frequency or frequencies can be varied.

Optionally, an electromechanical actuator 14 is associated with the vibration damper 4 and enables the vibration damper 4 to be slid continuously along the flat spring 8. For clarity, the actuator 14 in FIG. 1 is shown only simplified or schematically by dashed lines, but can be a rack and pinion or a work screw, for example. The actuator 14 also enables the vibration damper 4 to be slid or displaced remotely so that a complicated manual displacement by a person, for example a mechanic, is not required for this purpose. In this respect, the actuator 14 allows a simple and comfortable adjustment of the tuning frequency and frequencies.

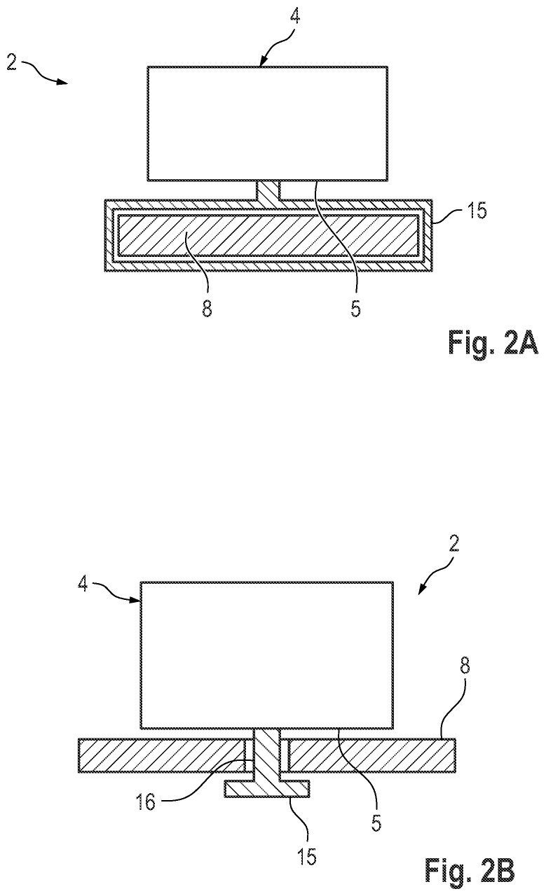

FIGS. 2A and 2B each show a cross-section along a cut line A-A shown in FIG. 1. The vibration damper 4 can have a mounting projection 15 extending away from the retainer 5 for slidably mounting the vibration damper 4 on the flat spring 8.

FIG. 2A shows the vibration damper 4 with a first embodiment of the mounting projection 15. This mounting projection 15 is configured to encompass the flat spring 8, as can be seen in the cross-section shown in FIG. 2A. Thus, the mounting projection 15 and the vibration damper 4 can be displaced along the longitudinal axis L of the flat spring 8 and can be brought at least to the first position 11 and the second position 12. The flat spring 8 functions essentially as a guide rail for the mounting projection 15. For example, the mounting projection 15 is fastened to the flat spring 8 starting from the free end 10 of the flat spring 8. A locking apparatus, such as a latching system or a magnetic system, preferably is associated with the vibration damper 4 or the mounting projection 15 to lock the mounting projection 15 or the vibration damper 4 at a definable position on the flat spring 8, such as the first position 11 or the second position 12.

FIG. 2B shows a second embodiment of the mounting projection 15. Elements of the second embodiment that correspond to the first embodiment are provided with the same reference numerals and only the differences are explained below. The embodiment of FIG. 2B differs from the embodiment of FIG. 2A in that the mounting projection 15 does not engage around the flat spring 8, but instead rearwardly engages the flat spring 8. When viewed in the cross-section of FIG. 2B, the mounting projection 15 is T-shaped or alternatively L-shaped and is inserted through an elongated hole 16 of the flat spring 8 running along the longitudinal axis L. In the embodiment of FIG. 2B, the mounting projection rearwardly engages with the flat spring through the elongated hole 16 running along the longitudinal axis L. Thus, the elongated hole 16 in the flat spring 8 acts as a guide rail for the mounting projection 15. This also enables the slidable mounting of the vibration damper 4 in a constructively easily implementable manner. Preferably, the aforementioned locking apparatus also is provided in the second embodiment.

The cross-sectional illustrations of FIGS. 2A and 2B show that the flat spring 8 has a rectangular cross-section. A width of the flat spring 8 is greater than a thickness of the flat spring 8 by a multiple, such as by a factor of 5. The flat spring 8 is flat and may be a stamped plate made of a metal. As a result, the flat spring 8 can be produced simply and inexpensively. The elongated hole 16 also can be produced in the flat spring 8 in a simple manner.

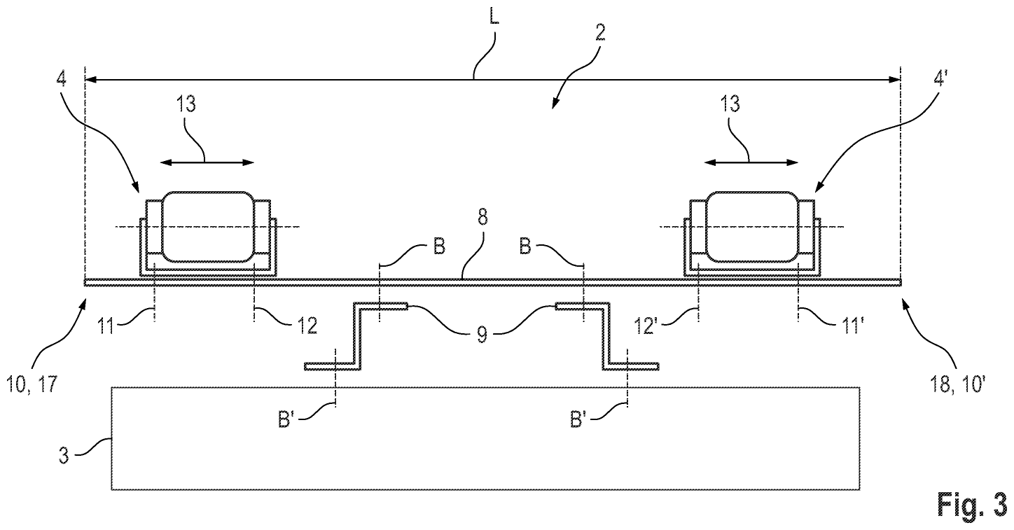

FIG. 3 shows a simplified schematic representation of an alternate to the damper arrangement 1 of FIG. 1. In this respect, comparable elements are provided with the same reference numbers, and only the differences are explained below.

As shown in FIG. 3, the damper arrangement 1 comprises a first vibration damper 4 and a second vibration damper 4′. The first vibration damper 4 is arranged in the region of a first free end 17 of the flat spring 8 and the second vibration damper 4′ is arranged in the region of a second free end 18, in particular a further free end 10′, and in this respect is spaced apart from the first vibration damper 4.

The second vibration damper 4′ may be identical to the first vibration damper 4 and also is mounted slidably on the flat spring 8 along the longitudinal axis L. The slidable mounting of the second vibration damper 4′ preferably is configured analogously to the slidable mounting of the first vibration damper 4, as explained above with reference to FIGS. 2A and 2B. In this respect, the second vibration damper 4′ on the flat spring 8 can also be brought into at least a further first position 11′ and into at least a further second position 12′ spaced from the further first position 11′ relative to the flat spring 8.

The FIG. 3 embodiment allows an even higher variability of the rigidity of the flat spring 8 and thus the tuning frequencies of the damper arrangement 1. In this respect, at least 4 different rigidities can be adjusted in the flat spring 8. As further shown in FIG. 3, the flat spring 8 is fastened to the rigid retaining element 9 at two fastening points B and thus is connected to the structure 3. Alternatively, however, the flat spring 8 can also be fixed to the retaining element 9 analogously to FIG. 1 with a single attachment point B.

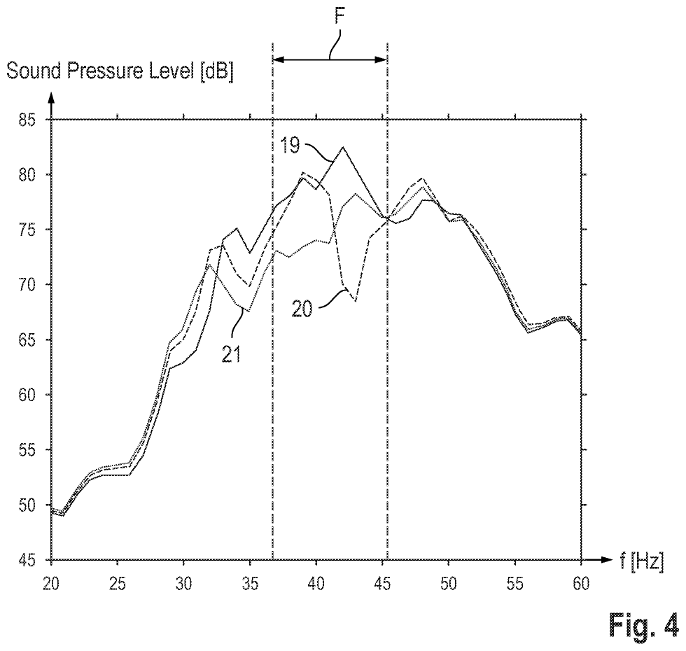

FIG. 4 is diagram illustrating the advantages of the damper arrangement 1 previously described. For this purpose, the diagram shows three variants of an exemplary vibration spectrum of the structure 3, with the respective frequencies recorded on the abscissa and the corresponding sound pressure level recorded on the ordinate.

The first graph 19 represents the vibration spectrum of the structure 3 in the absence of the vibration damper 4 or the damper arrangement 1, the second graph 20 shows the presence of a vibration damper of the prior art, and the third graph 21 in the presence of the previously discussed damper arrangement 1.

As can be seen in FIG. 4, in the case of the first graph 19, the sound pressure level in an exemplary selected frequency range F is comparatively high, because vibrations of the structure 3 are not absorbed due to the lack of a vibration damper.

If a vibration damper known from the prior art, whose tuning frequency is in the frequency range F, is present, only a portion of the vibrations are absorbed by the vibration damper in this frequency range F, as can be easily seen from the second graph 20, because the known vibration damper only has a narrow band effect.

The third graph 21 represents the advantageous damper arrangement 1 with a broadband effect and tuning frequencies tuned to the frequency range F. The third graph 21 shows that the vibrations of the structure 3 are dampened over the entire frequency range F, so that the sound pressure level over the entire frequency range F is dampened on average than in the case of the two other graphs 19 and 20. In this respect, the damper arrangement 1 is effective when compared to known solutions in a broader frequency range. Thus, the damping of vibrations of the structure 3 is improved significantly by the damper arrangement 1.

1. A motor vehicle (2) comprising at least one mechanical structure (3) and a vibration damper (4) associated with the structure (3) for damping vibrations of the structure (3), the vibration damper (4) having a retainer (5) and a damper mass (7) resiliently mounted in the retainer (5) by a spring element (6), the vibration damper (4) and the structure (3) being mounted on the flat spring (8) for selected slidable movement on the flat spring (8) along a longitudinal axis (L) of the flat spring (8), wherein the vibration damper (4) and the flat spring (8) collectively form a damper arrangement (1) in which the spring element (6) and the flat spring (8) are connected in series.

2. The motor vehicle (2) of claim 1, wherein the vibration damper (4) is mounted slidably relative to the flat spring (8) such that the vibration damper (4) can be brought into at least a first position (11) and a second position (12) spaced from the first position (11) relative to the flat spring (8).

3. The motor vehicle (2) of claim 1, wherein the vibration damper (4) comprises a mounting projection (15) extending away from the retainer (5), the mounting projection passing through an elongated hole (16) running along the longitudinal axis (L) of the flat spring (8) and engaging rearwardly with the flat spring (8).

4. The motor vehicle (2) of claim 1, wherein the vibration damper (4) comprises a mounting projection (15) engaging around the flat spring (8).

5. The motor vehicle (2) of claim 1, wherein the flat spring (8) has a rectangular cross-section.

6. The motor vehicle (2) of claim 5, wherein the flat spring (8) is a metal plate.

7. The motor vehicle (2) of claim 5, wherein the flat spring (8) is a stamped metal plate.

8. The motor vehicle (2) of claim 1, wherein the spring element (6) is made of an elastomeric material.

9. The motor vehicle (2) of claim 1, further comprising an electromechanical actuator (14) associated with the vibration damper (4) and configured to move the vibration damper (4) slidably along the flat spring (8).

10. The motor vehicle (2) of claim 1, wherein the flat spring (8) is fastened to the structure (3) by a rigid retaining element (9) at a fastening point (B), and the retaining element (9) is configured such that the flat spring (8) has a fixed distance (A) from the structure (3) in a fastened state at the fastening point (B).

11. The motor vehicle (2) of claim 1, wherein the vibration damper (4) is a first vibration damper (4) arranged in a first end region (17) of the flat spring (8), and the damper arrangement (1) further comprising a second vibration damper (4′) spaced apart from the first vibration damper (4) and arranged at a second end region (18) of the flat spring (8), and the second vibration damper (4′) being mounted for sliding movement along the longitudinal axis (L) of the flat spring (8).
